(19) United States
(12) Patent Application Publication
(10) Pub. No.: US 2016/0063394 A1
(43) Pub. Date: Mar. 3, 2016

(54) Computing Device Classifier Improvement Through N-Dimensional Stratified Input Sampling

(71) Applicant: Microsoft Corporation, Redmond, WA (US)

(72) Inventors: Sedat Gokalp, Bellevue, WA (US); Graham Sheldon, Bellevue, WA (US); Salem Haykal, Bellevue, WA (US)

(21) Appl. No.: 14/470,892

(22) Filed: Aug. 27, 2014

(51) Int. Cl. G06N 99/00; G06F 17/30

(52) U.S. Cl. CPC G06N 99/005; G06F 17/30598; G06F 17/30864

(57) ABSTRACT

Discrete sets of data are divided into collections in accordance with strata delineated along multiple dimensions of data. Each dimension of data represents criteria to be evaluated and the stratification of a dimension is based on a distribution of the discrete sets of data along such a dimension. Once divided into the multidimensional strata, one or more discrete sets of data are randomly selected from each stratum and are provided to human judges to generate corresponding classifications of such a discrete set of data. Such human-generated classifications are compared with computer-generated classifications associated with the same discrete sets of data for purposes of evaluating the computer-implemented functionality generating such classifications. Such human-generated classifications are also associated with the corresponding discrete sets of data for purposes of training, and thereby improving, computer-implemented functionality.

### BACKGROUND

Computer-implemented functions are often verified by human users to detect errors, perform debugging, and otherwise optimize and improve such computer-implemented functions. Such verification by human users can be especially useful in instances where the computer-implemented functions mimic the application of human intelligence to specific tasks, such as judgment tasks or other heuristic analysis. Typically, the range of variance of computer-implemented functions is sufficiently small that the selection of the specific computer-implemented functions to verify can be immaterial. For example, a computer-implemented function can parse a database of product failures to classify such failures into various categories such as, for example, design flaws, individual component failures, and the like. In such an example, the operation of such a computer-implemented function can be verified by selecting some of the product failures that were categorized by the computer-implemented function as design flaws, some that were categorized as individual component failures, and so on, and then determining whether those same product failures were categorized in the same way by human users. Such a verification could reveal, for example, that the computer-implemented function was incorrectly categorizing some product failures as design flaws. Such a revelation could then be utilized to adjust, and thereby improve, the computer-implemented function.

In certain instances, however, the breadth of the variety of the functionality performed by computer-implemented functions, as well as the sheer quantity of individual instances in which those computer-implemented functions rendered results, can make the verification of such computer-implemented functionality difficult. For example, a search engine can receive millions of individual search queries each day. While many of those search queries may each be directed to the same common searches, such as for a popular performer or event, many other queries may each be directed to a unique and unusual search. A simple random sampling of such queries in aggregate may result in popular searches being evaluated by human users more than once, creating inefficient repetition at the expense of not evaluating less common queries. Conversely, a random sampling from among different queries, irrespective of a quantity of individual instances of such different queries, risks no verification of one or more common queries. Analogous trade-offs exist in verification of computer-implemented functions in social networking, knowledge graphs, and other areas where the computer-implemented functions are accessed frequently, and across a breadth of variety.

### SUMMARY

Discrete sets of data can be divided into collections in accordance with strata delineated along multiple dimensions of data. Each dimension of data can represent criteria to be evaluated and the stratification of a dimension can be based on a distribution of the discrete sets of data along such a dimension. Once divided into the multidimensional strata, one or more discrete sets of data can be randomly selected from each stratum and can be provided to human judges to generate corresponding classifications of such a discrete set of data. Such human-generated classifications can be compared with computer-generated classifications associated with the same discrete sets of data for purposes of evaluating and verifying the computer-implemented functionality generating such classifications. Such human-generated classifications can also be associated with the corresponding discrete sets of data for purposes of training, and thereby improving, computer-implemented functionality.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Additional features and advantages will be made apparent from the following detailed description that proceeds with reference to the accompanying drawings.

### DESCRIPTION OF THE DRAWINGS

The following detailed description may be best understood when taken in conjunction with the accompanying drawings, of which:

FIG. 1 is a block diagram of an exemplary system for improving a computing device classifier by performing n-dimensional stratified sampling;

FIG. 2 is a block diagram of an exemplary system for performing n-dimensional stratified sampling and subsequent training or evaluation therefrom;

FIG. 3 is an exemplary visualization of the stratification of quantities of discrete sets of data along multiple dimensions;

FIG. 4 is a flow diagram of an n-dimensional stratified sampling and subsequent training or evaluation therefrom; and

FIG. 5 is a block diagram of an exemplary computing device.

### DETAILED DESCRIPTION

The following description relates to the improvement of a computing device's classification functionality through selective sampling of an otherwise overwhelmingly large compilation of discrete sets of data representing input to the computing device's classification functionality and corresponding classification output generated by such functionality. Discrete sets of data from such an overwhelmingly large compilation can be divided into individual collections in accordance with strata delineated along multiple dimensions of data. Each dimension of data can represent criteria to be evaluated and the stratification of a dimension can be based on a distribution of the discrete sets of data along such a dimension. Once divided into the multidimensional strata, one or more discrete sets of data can be randomly selected from each stratum and can be provided to human judges to generate corresponding classifications of such a discrete set of data. Such human-generated classifications can be compared with computer-generated classifications associated with the same discrete sets of data for purposes of evaluating the computer-implemented functionality generating such classifications. Such human-generated classifications can also be associated with the corresponding discrete sets of data for purposes of training, and thereby improving, computer-implemented functionality.

The techniques described herein focus on the improvement of a computing device's classification functionality within the context of online searching and knowledge provision. Classification functionality within such a context includes classifying searches as being of a specific type, such as searches for factual information, searches for directions, searches for product pricing, and the like, as well as classifying the information searches are directed to, such as searches for chocolate cake recipes, searches for movie times, searches for carpet stain removal techniques and the like. However, such descriptions are not meant to suggest a limitation of the described techniques. To the contrary, the described techniques are equally applicable to any heuristic analysis improvable through human verification and training, including, for example, social network analysis, such as degree centrality, closeness centrality and impact rate, knowledge analysis, such as pagerank and entity identification, automated image analysis, such as facial recognition, highlight/shadow adjustment and color adjustments, linguistic analysis, such as grammatical correction and meaning extraction, as well as other types of heuristic analysis, including those based on machine-learning algorithms. Consequently, as utilized herein, the word “classification” means a determination, based on a defined set of inputs, that the inputs evidence a pre-defined category or factor.

Although not required, the description below will be in the general context of computer-executable instructions, such as program modules, being executed by a computing device. More specifically, the description will reference acts and symbolic representations of operations that are performed by one or more computing devices or peripherals, unless indicated otherwise. As such, it will be understood that such acts and operations, which are at times referred to as being computer-executed, include the manipulation by a processing unit of electrical signals representing data in a structured form. This manipulation transforms the data or maintains it at locations in memory, which reconfigures or otherwise alters the operation of the computing device or peripherals in a manner well understood by those skilled in the art. The data structures where data is maintained are physical locations that have particular properties defined by the format of the data.

Generally, program modules include routines, programs, objects, components, data structures, and the like that perform particular tasks or implement particular abstract data types. Moreover, those skilled in the art will appreciate that the computing devices need not be limited to conventional personal computers, and include other computing configurations, including hand-held devices, multi-processor systems, microprocessor based or programmable consumer electronics, network PCs, minicomputers, mainframe computers, and the like. Similarly, the computing devices need not be limited to stand-alone computing devices, as the mechanisms may also be practiced in distributed computing environments where tasks are performed by remote processing devices that are linked through a communications network. In a distributed computing environment, program modules may be located in both local and remote memory storage devices.

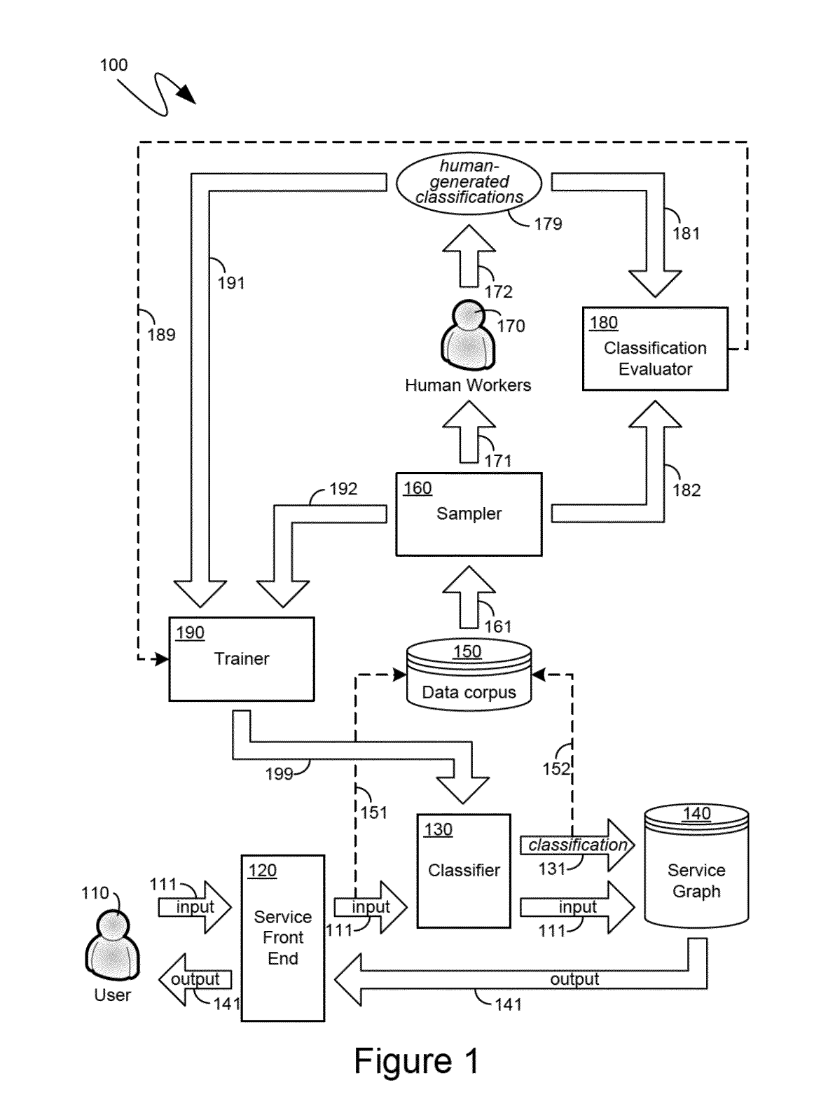

With reference to FIG. 1, an exemplary system 100 is illustrated, providing context for the descriptions below. As illustrated in FIG. 1, the exemplary system 100 can comprise a service having a user-facing service front end 120 with which a user 110 can interact, including by providing input 111 thereto, and receiving output 141 therefrom. As indicated previously, such a service can provide functionality, to the user 110, based upon heuristic analysis of the input 111. For example, the service can be a search service, a social networking service, a knowledge service, an image processing service, a translation or linguistic analysis service, or other like services. The input 111, provided to such a service via the service front end 120, by a user 110, can be provided to a classifier 130 that can generate a classification 131 of the input 111. Such a classification 131 can be utilized to define aspects of a service graph 140 that can, in combination with the input 111, generate the output 141, which can be returned to the user 110, such as via the service front end 120. As indicated previously, the word “classification”, as utilized herein, means a determination, based on a defined set of inputs, that the inputs evidence a pre-defined category or factor. Consequently, if the service is a search service, and the input 111 a search query, then the classifier 130 can provide a classification 131 that can classify the search query as, for example, a query directed to obtaining factual information, or, as another example, the query directed to obtaining directions, or product pricing, or any of a myriad of other predetermined classifications. As another example, the classification 131 can be even more specific, such as, for example, classifying a query, not merely as a query directed to obtaining factual information, but, more specifically, a query for a chocolate cake recipe, for example. Similarly, a query could be classified, not merely as a query for obtaining product pricing, but, more specifically, a query for obtaining the product pricing for a specific product.

While the above examples have been provided within the context of search functionality, analogous classifications, as that term is utilized herein, can be performed within other contexts including, for example, social network analysis, image analysis, linguistic analysis, and other types of heuristic analysis. For example, within a social networking context, the classification 131, generated by the classifier 130, can classify the input 111 as, for example, a request for a connection between two entities, a request for a determination of impactfulness of one or more individuals, and so forth. Similarly, as another example, within an automated image analysis context, the classification 131, generated by the classifier 130, can classify the input 111 as, for example, an image whose contrast should be adjusted, a selection of an area of an image to which a white point is to be tuned, an image of a human face that is to be identified in other images, and so forth.

In many situations, as illustrated by exemplary system 100 of FIG. 1, existing information available to the service, which the service can utilize to respond to the input 111, such as via the output 141, can be organized and retained in a knowledge or information graph, generically referred to as the service graph 140. For example, if the service is a search service, then the service graph 140 can be a search graph, knowledge graph, or other like data structure. As another example, if the service is a social networking service, then the service graph 140 can be a social network graph.

To provide for monitoring, and subsequent improvement, of the service, and, more specifically, the classifier 130, information including the input 111 and the classification 131 can be logged, as indicated by the dashed lines 151 and 152, respectively, into a data corpus 150. As will be described in further detail below, such a data corpus 150 can source relevant information that can be utilized to analyze, train, and thereby improve the operation of a classification computing device, such as one or more computing devices executing the classifier 130. However, as indicated previously, and as will be recognized by those skilled in the art, for many of the aforementioned services, the data corpus 150 can comprise such a large volume of data that mechanisms utilized to select specific, discrete sets of data from such a data corpus 150, such as a specific, single input 111, and a corresponding classification 131, may not be appropriately representative of the overall data corpus 150 insofar as monitoring and improving the operation of the classifier 130 is concerned. For example, within the specific, exemplary, context of online searching functionality, the data corpus 150 can comprise search queries performed by different users, with many of those search queries being common queries that are individually repeated many different times, while many other queries can be uncommon queries that are individually repeated rarely, if at all. Consequently, a random sampling of the data corpus 150 can select common search queries multiple times, due to the volume of such queries within the data corpus 150 while, conversely, such a random sampling would not select many of the uncommon queries. For purposes of evaluating the operation of the classifier 130, the benefit from evaluating multiple instances of the same, common query can be minimal. To counter the multiple selection of common search queries in a random sampling of the data corpus, a random sampling of discrete search queries can be performed, where the chance of sampling a common search query is equivalent to the chance of sampling an uncommon search query. Such a random sampling of discrete search queries, however, may not select one or more of the common search queries, thereby failing to evaluate and improve the operation of the classifier 130 with respect to those search queries, and thereby increasing the possibility that users of the service will encounter situations in which the service is performing suboptimally.

In accordance with one aspect, a sampler 160 can sample the data corpus 150, as illustrated by the arrow 161, and can provide those samples to human workers, such as the exemplary human workers 170, as illustrated by the arrow 171. The sampling employed by the sampler 160 can, as will be described in further detail below, take into account unevenness in the data corpus 150, such as that exemplarily illustrated above, and can sample the data corpus 150 such that the samples provided to the human workers 170, represented by the arrow 171, can comprise a more accurate representation of the data corpus 150 for purposes of evaluating and training, and thereby improving, the classifier 130. More specifically, the human workers 170 can, based on originally provided user input that was logged into the data corpus 150, independently generate human-generated classifications 179. As such, the human workers 170 can apply human intelligence to generate classifications, namely the human generated classifications 179, based on the same input that was, at some prior time, provided to the classifier 130. For example, a user, such as the user 110, can have provided input 111 in the form of a search query presented as “is flight AB123 on time”. The classifier 130 can then generate the classification 131 for such a query. For example, the classifier 130 can generate a classification 131 identifying the query as a request for historical information regarding the previous timeliness of flight AB 123. Such an input can have been logged into the data corpus 150, as illustrated by the dashed line 151, and can have been selected by the sampler 160, as represented by the arrow 161, and then provided to one of the human workers 170, as represented by the arrow 171. Such a human worker 170 can consider the same “is flight AB123 on time” query and can generate a human-generated classification 179 for such a query. For example, the human worker 170 can generate a human-generated classification 179 identifying the query as a request for a current flight status, namely that of flight AB123.

The human-generated classifications 179 can then be utilized to both evaluate the classifications previously generated by the classifier 130, which, as indicated previously, can also have been logged into the data corpus 150, as illustrated by the dashed line 152, as well as to generate training data that can be utilized to improve the operation of the classifier 130. Turning first to the former utilization, the human-generated classifications 179 can be provided to a classification evaluator 180, as illustrated by the arrow 181. Such a classification evaluator 180 can further obtain, such as from the sampler 160, the corresponding classification that was previously assigned by the classifier 130 to the input of the data set that was selected by the sampler 160 from among the data corpus 150. For example, the sampler 160 can have selected, from the data corpus 150, a discrete set of data comprising both the input 111, in the form of the aforementioned “is flight AB123 on time” search query, as well as the classification 131, assigned by the classifier 130, to such an input. As indicated by the dashed lines 151 and 152, such an input 111, and corresponding classification 131, can both have been logged into the data corpus 150, and can be treated as a discrete set of data for purposes of being sampled by the sampler 160. Consequently, as utilized herein, the term “discrete set of data” means a collection of individual quanta of data that are related as being either input to a function or the corresponding output of such a function given such input, and which are stored in such a manner that such a relationship is explicitly indicated. Thus, the classification evaluator 180 can request, such as from the sampler 160, the output portion of the discrete set of data whose input portion the sampler provided to the human workers 170 in order for them to generate the human generated classifications 179. In the aforementioned example, the sampler 160 can provide, to the human workers 170, the “is flight AB123 on time” search query, as represented by the arrow 171. The corresponding classification 131 that was assigned to such a search query, by the classifier 130, can be provided, by the sampler 160, to the classification evaluator 180, as illustrated by the arrow 182. The classification evaluator 180 can then compare the classification 131, generated by the classifier 130, to the human generated classification 179, generated by the human worker 170, given the same “is flight AB123 on time” search query as input.

Should the human-generated classifications 179 match the classifications 131, which were generated by the classifier 130 and logged into the data corpus 150, the classification evaluator 180 can determine that, for the input that generated such classifications, the classifier 130 appears to be functioning optimally. Conversely, should there be differences between the human-generated classifications 179 and the classifications 131 that were generated by the classifier 130, the classification evaluator 180 can treat the human-generated classifications 179 as being the correct classifications and can, thereby, determine that, at least for the inputs that generated such classifications, the classifier 130 is operating suboptimally.

In addition to being utilized to evaluate the operation of the classifier 130, the human generated classifications 179, generated by the human workers 170, can also be utilized to generate training data that can be utilized to further train, and thereby improve the operation of, a classifier 130. More specifically, as illustrated in the exemplary system 100 of FIG. 1, a trainer 190 can generate training data by combining the human-generated classifications 179, as illustrated by the arrow 191, with the corresponding input which caused the human workers 170 to generate such human-generated classifications 179, as obtained from the sampler 160, as illustrated by the arrow 192. For example, returning to the above example of a search query in the form of “is flight AB123 on time”, such a search query can have been made by a user, such as the user 110, can have been logged into the data corpus 150, can have been sampled therefrom by the sampler 160, and provided to a human worker, such as the human worker 170, who can have generated a human-generated classification 179, classifying such a search query as a request for a current flight status. The trainer 190 can then generate training data by associating such a classification, generated by the human worker 170, which can be treated as the correct classification, with the corresponding input that caused the human worker 170 to generate such a classification, namely the search query in the form of “is flight AB123 on time”. Such training data can then be provided to the classifier 130 to adjust or modify the algorithms and mechanisms utilized by the classifier 130 to generate the classification 131, thereby improving the operation of the classifier 130.

For example, if the classifier 130 relies on “machine learning” algorithms, such algorithms, as will be recognized by those skilled in the art, can be based on different weightings or factors that are applied to various attributes or portions of the inputs to such algorithms. The training data provided by the trainer 190, such as is illustrated by the arrow 199, can enable the classifier 130 to adjust the weightings and factors applied to the attributes or portions of the inputs, as well as to adjust which attributes or portions are utilized, in order to generate more accurate classifications 131.

According to one aspect, the training data generated by the trainer 190 can be informed by the classification evaluator 180, as graphically represented by the dashed line 189. More specifically, the trainer 190 can request, from the sampler 160, those samples corresponding to aspects of the classifier 130 that the classification evaluator 180 determined to be suboptimal. For example, if the classification evaluator 180 determined that a request for a current flight status was classified differently by the classifier 130 than by the human workers 170, such an evaluation can be communicated to the trainer 190, and the trainer 190 can request, from the sampler 160, samples directed to flight status requests, as well as other similar requests, such as, for example, train status requests, airport status requests, and the like. The trainer 190 can then generate targeted training data from the input search queries of the samples provided by the sampler 160 in combination with the corresponding human generated classifications 190.

Before proceeding with further detailed descriptions regarding the operation of the sampler 160, the contents of the data corpus 150 are described further herein. More specifically, while the data corpus 150 has been described above within the context of search queries for a particular set of factual data, the input 111, received by the service front-end 120, from the user 110, is not so limited. For example, the input 111 can comprise search queries that can reference, be based on, or can otherwise be impacted by information as diverse as user relationships in a social network, tags and metadata associated with images, correct identification of products available for sale and other like information. As one specific example, the classification 131 can comprise determining whether a specific image is of a specific product. In such a specific example, the relevant portion of the data corpus 150 can comprise an association between that specific image and the product that the classifier 130 has determined is depicted within the image. As another specific example, the classification 131 can comprise a determination that the user 110 is linked to one or more other individuals, such as within a social network context. In such a specific example, the relevant portion of the data corpus 150 can comprise the association between the user 110 and the one or more other individuals. In light of the foregoing, the data corpus 150, within the context of the descriptions provided herein, is a collection of data representing both inputs received from users of a service, as well as determinations or associations utilized by such a service to respond to such inputs. As such, mechanisms described herein improve the classifier 130, utilized by such a service, by double-checking, via the application of human intelligence, such as by the human workers 170, the determinations and associations that are part of the data corpus 150. Such double-checking can reveal sub-optimalities in the classifier 130, which can subsequently be corrected or improved, such as via the training mechanisms described in detail herein.

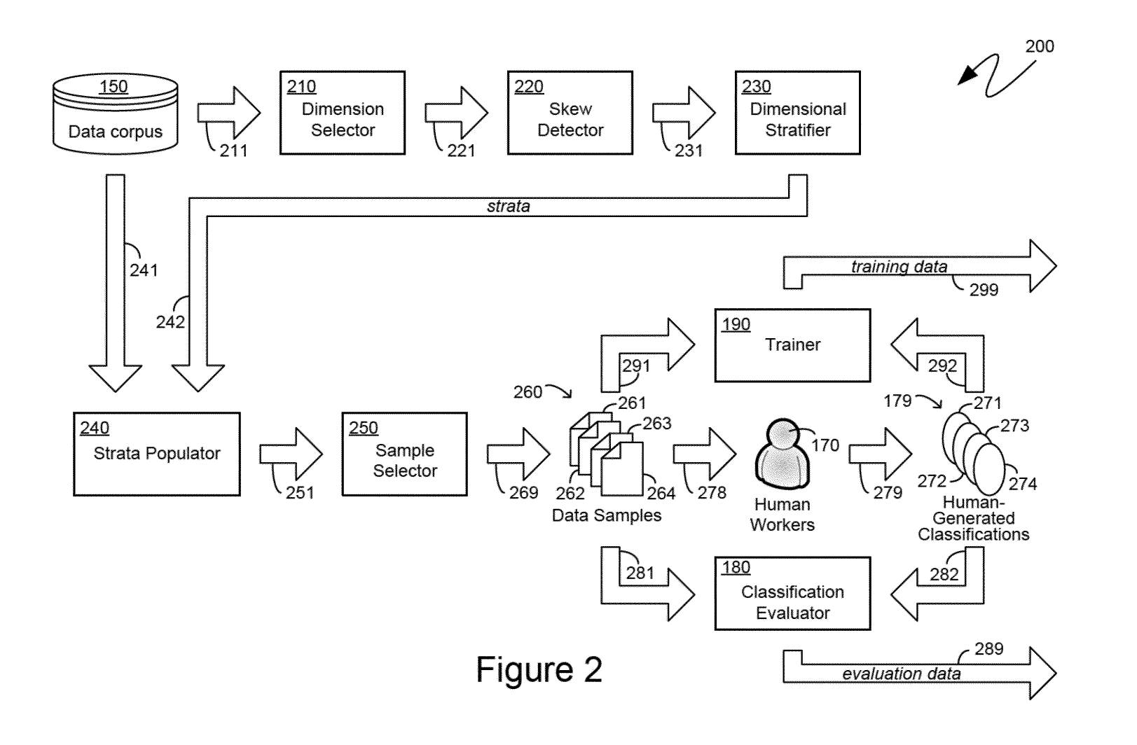

Turning to FIG. 2, the system 200 shown therein illustrates components and aspects of the sampler 160, whose operation was described above and illustrated in FIG. 1. Initially, as illustrated, a dimension selector 210 can select one or more dimensions along which the data corpus 150 is to be analyzed. Such dimensions can be based on various aspects of the data corpus 150, such as classifications that were logged as part of the data corpus 150, factors present in the input that was logged as part of the data corpus 150, as well as metadata that can have been generated and logged with the data corpus 150. Metadata that can be logged as part of the data corpus 150 can include confidence metrics, such as values reflecting a degree of confidence in the output generated by the functionality being evaluated. Metadata can also include categorization of input provided to such functionality, such as whether such input is common or unusual. Thus, referring back to the specific example of search functionality, metadata can include indicia indicating whether a search query is a commonly repeated search query, or whether it is an unusual search query. Other types of metadata are equally possible and utilizable with the mechanisms described herein.

The dimensional selector 210 can retrieve information from the data corpus 150, as illustrated by the arrow 211, and can identify dimensions along which the data corpus 150 can be analyzed. A user can then select one or more of the identified dimensions. For example, a user may wish to evaluate the operation of the classifier across a range of, for example, queries having different levels of popularity, as well as across a range of confidences in the resulting classifications. In such an example, a user could select, such as via the dimensional selector 210, multiple dimensions including, for example, a popularity dimension as well as a confidence dimension. Alternatively, the dimensional selector 210 can, itself, select dimensions along which the data corpus 150 can be analyzed. For example, the dimensional selector 210 can proceed to automatically select combinations and permutations of various dimensions, such as for an automated analysis of the data corpus 150.

Subsequently, the data corpus 150, which, as indicated, can comprise individual, discrete sets of data that can comprise both an input and a corresponding output of a functionality being evaluated and improved, can be evaluated by a skew detector 220 within the context of the dimensions selected by the dimensional selector 210, as illustrated by the arrow 221. As indicated previously, in certain instances, data can be skewed along various dimensions. For example, returning to the above example of popularity of search query, as will be recognized by those skilled in the art, certain search queries are very popular in that they are repeated many thousands of times even within the span of just a few hours. For example, search queries directed to a newsworthy event can be individually submitted by millions of users in the hours and days following such an event, resulting in millions of incidents of such, essentially identical, search queries. By contrast, other search queries, such as search queries directed to specific, limited-interest topics, can be very infrequently performed. While each such search queries may be submitted only a handful of times, there can exist many thousands, or even millions of such unpopular search queries. One rule of thumb that is often utilized to conceptualize such a data skew is the 80/20 rule, which posits that 80% of the aggregate quantity of, for example, searches, are directed to a mere 20% of the search queries, while the remaining 80% of search queries have only 20% of the aggregate quantity of searches directed to them.

A skew detector, such as the exemplary skew detector 220, can detect such a skew in the data corpus 150 and can appropriately inform a dimensional stratifier, such as the exemplary dimensional stratifier 230. More specifically, according to one aspect, if the skew detector 220 determines that the data corpus 150 is not skewed, and is more evenly distributed along the dimensions selected by the dimension selector 210, then more traditional sampling mechanisms, such as, for example, a pure random sampling, may result in acceptable performance, insofar as evaluation and training of systems, such as exemplary classifier described in detail above. However, if the skew detector 220 determines that the data corpus 150 is skewed, such as in the manner described, it can inform a dimensional stratifier, such as the exemplary dimensional stratifier 230, as illustrated by the arrow 231. The dimensional stratifier 230 can utilize such information regarding the skew of the data to establish upper and lower thresholds of individual strata along each of the dimensions selected by the dimensional selector 210. For example, for skewed data approximating the 80/20 rule described above, the dimensional stratifier 230 can choose to identify upper and lower thresholds of individual strata in accordance with a logarithmic, or exponential, scale. By way of a simple example, ranking search queries from most popular to least popular, one stratum can be delineated by an upper and lower bound of the most popular search query, such that the stratum comprises only the one most popular search query. A subsequent stratum can then be delineated by a lower bound of the second most popular search query, and an upper bound of the tenth most popular search query. A still further, subsequent stratum can then be delineated by a lower bound of the eleventh most popular search query, and an upper bound of the one-hundredth most popular search query. In such a manner, assuming a exponential distribution of quantities of searches across the enumerated search queries, each stratum can comprise an approximately equivalent quantity of search queries. Other variations in the skew of the data can be similarly accounted for by the dimensional stratifier 230.

While the skew detector 220 and the dimensional stratifier 230 have been described within the context of computer-implemented processes, such as those performed by the execution of computer-executable instructions by processing units of one or more computing devices, according to another aspect, the functionality of the skew detector 220 and the dimensional stratifier 230 can be implemented by a human user. For example, a human user can be provided with summary information regarding the data corpus 150, and can, based on such summary information, determine, on their own, whether such data is skewed, and the nature in which it is skewed along whichever dimension is of interest to such a human user. Furthermore, such a human user can, likewise, themselves establish upper and lower bounds of individual strata along one or more of the dimensions being stratified. In yet another aspect, a human user's performance of such skew detection and dimensional stratification can be aided by automated processes that can, for example, automatically summarize aspects of a stratification being considered by the human user. For example, a user interface comprising sliders or other like user interface elements by which a human user can vary upper and lower boundaries of strata can be provided, together with quantitative or qualitative feedback regarding the impact of changes in the upper and lower boundaries of strata attempted by the human user. For example, the human user can establish preliminary upper and lower boundaries, and automated processes can provide, in response to such preliminary upper and lower boundaries, information such as, for example, an aggregate quantity of discrete data sets within each such stratum to enable the human user to determine whether the preliminary upper and lower boundaries accomplish the intended goals of the human user insofar as stratifying, and then subsequently sampling, the data corpus 150.

Once strata along the selected dimensions have been established, such strata can be provided to a strata populator, such as the exemplary strata populator 240, as illustrated by the arrow 242. The strata populator 240 can then divide the various discrete sets of data, from the data corpus 150, into the identified strata. Such strata population can utilize any mechanism by which the various discrete sets of data, from the data corpus 150, can be divided, or “bucketized”, into the identified strata based on the upper and lower boundaries of such strata along the dimensions selected. For example, one simple mechanism by which the strata populator 240 can divide the individual, discrete sets of data, from the data corpus 150, into the identified strata can be to proceed sequentially through the data corpus 150, selecting an individual, discrete set of data, placing it into an appropriate strata in accordance with the dimensions selected and the values of such a selected individual, discrete set of data as compared with the upper and lower boundaries of the strata along the dimensions selected, then selecting a subsequent, individual, discrete set of data, placing it into an appropriate strata, and so forth. As another example, another simple mechanism by which the strata populator 240 can divide the individual, discrete sets of data, from the data corpus 150, into the identified strata can be to cycle through the data corpus 150 searching for individual, discrete sets of data matching the criteria of a given stratum, then once such a stratum has been populated, incrementing to a subsequent stratum, and repeating the cycling through the data corpus 150. As will be recognized by those skilled in the art, other processes for populating the strata with the data corpus 150 can be equally effective, and can be utilized in place of those detailed above.

After the individual, discrete sets of data, from the data corpus 150, have been divided into collections in accordance with the defined strata, such as by the strata populator 240, such collections can be provided to the sample selector 250, as illustrated by the arrow 251, and the sample selector 250 can select data samples 260 from such collections. More specifically, according to one aspect, the sample selector 250 can select one sample, such as one of the data samples 261, 262, 263 or 264, from each of the collections into which such discrete sets of data have been divided by the strata populator 240. According to another aspect, two or more samples can be selected from each collection of the individual, discrete sets of data.

In some instances, the sample selector 250 may only select samples from those strata from which it has not already, previously selected a sample. More specifically, the described mechanisms can efficiently accommodate updates to the data corpus 150, changes to the dimensions that were selected by the dimensional selector 210, changes to the stratification applied by the dimensional stratifier 230, or combinations thereof. By way of a simple example, the above described mechanisms can have already been applied to a prior version of the data corpus 150, and the sample selector 250 can have selected data samples 260 from each of the strata given the dimensions selected by the dimensional selector 210 and the stratification of those dimensions established by the dimensional stratifier 230. Subsequently, the data corpus 150 can be updated such that the dimensional stratifier 230, in the present simple example, delineates different strata along one dimension that merely split existing strata along that dimension into two. In such a simple example, after the strata populator 240 divides the updated data corpus 150 into the new strata identified by the dimensional stratifier 230, the sample selector 250 can proceed through each of the strata and can first determine whether an existing one or more of the data samples 260, that were previously selected, are now part of one of the strata. For example, in the present simple example, since strata along one dimension were merely split into two, for any given set of two strata, that were previously one stratum, one of the data samples 260, previously selected by the sample selector 250 from such a stratum, will now be divided into one of the two new strata. For such a stratum into which an existing sample has been divided, no additional sample need to be selected by the sample selector 250, and the sample selector 250 can simply skip over such a stratum and can proceed to strata from which no samples have yet been selected.

Because existing samples remain valid, the sample selector 250 can simply look for strata from which no data samples have previously been selected and, in such a manner, efficiently accommodate stratification changes. To the extent that a subsequent change in stratification results in certain strata having two or more data samples from such strata, while other strata are only having a single sample being selected therefrom, the sample selector 250 can, according to one aspect, discard samples from strata to ensure that an equivalent number of samples are selected from each stratum. According to another aspect, however, to the extent that certain strata can have a greater quantity of sample selected therefrom, such as due to a subsequent change in the stratification, such additional samples can be dealt with utilizing other mechanisms such as, for example, applying a different weighting to such samples. In such a manner, because the sample selector 250 need only select data samples from those strata, as currently defined, from which it has not previously selected a sample, the system can be said to have a high degree of “maintainability”.

As indicated previously, once the data samples 260 are selected, such as by the sample selector 250, they can be utilized to either evaluate computer-implemented functionality, such as the classification functionality described above, or to train such functionality. For example, and as indicated previously, each of the individual data samples 261, 262, 263 and 264 can comprise a specific input, such as a specific search query, that can have been provided to, for example, the aforementioned classifier. Such input can be provided, as illustrated by the arrow 278, to the human workers 170, who can generate, as illustrated by the arrow 279, corresponding human-generated classifications 179. More specifically, and as a specific example, one of the human workers 170 can receive the portion of the data sample 261 representing the input, such as the input to the aforementioned classifier. Such a human worker can then apply human intelligence and can, as a result of such an application of human intelligence, generate a corresponding human-generated classification 271, classifying the input from the data sample 261. In a similar manner, a human worker can generate the human-generated classification 272, classifying the input obtained from the data sample 262, the human-generated classification 273, classifying the input obtained from the data sample 263, and the human-generated classification 274, classifying the input obtained from the data sample 264. Such data samples 260 and corresponding human-generated classifications 179 can be provided to a classification evaluator 180, as illustrated by the arrows 281 and 282, respectively, thereby enabling the classification evaluator 180 to generate the evaluation data 289, or can be provided to a trainer 190, as illustrated by the arrows 291 and 292, respectively, thereby enabling the trainer 190 to generate the training data 299.

Turning first to the classification evaluator 180, as detailed above, the classification evaluator 180 can compare the human-generated classifications 179 to machine-generated classifications from the data samples 260 corresponding to the same input. More specifically, and as a specific example, the classification evaluator 180 can compare the human-generated classification 271 to the machine-generated classification that is part of the data sample 261, which also comprises the input that was classified by both the human worker 170, in the form of the human-generated classification 271, and was also classified by the aforementioned classifier, in the form of the classification that is part of the data sample 261 to which the human-generated classification 271 is being compared. In such a manner, the classification evaluator 180 can compare classifications performed by the classifier, and by a human, both classifying the same input. In an analogous manner, the classification evaluator 180 can compare the human-generated classification 272 to the machine-generated classification that is part of the data sample 262, the human-generated classification 273 to the machine-generated classification that is part of the data sample 263, the human-generated classification 274 to the machine-generated classification that is part of the data sample 264, and so on.

As indicated previously, for purposes of performing an evaluation, the classification evaluator 180 can generate the evaluation data 289 as if the human generated classifications 179 represent the correct classifications for the corresponding input. Thus, to the extent that the classification evaluator 180 determines that a human-generated classification is the same as a computer-generated classification for the same input, the classification evaluator 180 can generate evaluation data 289 indicating that the classifier is operating properly, insofar as such input is concerned. Conversely, to the extent that the classification evaluator 180 determines that a human-generated classification differs from a computer-generated classification for the same input, the classification evaluator 180 can generate evaluation data 289 indicating that the classifier is operating suboptimally insofar as such input is concerned.

According to one aspect, the weight applied to different evaluations, from among the evaluation data 289, can differ in accordance with the stratum from which the corresponding data sample was sourced, such as by the sample selector 250. For example, returning to the example of search queries, evaluation data 289 indicating that the classifier is incorrectly classifying a common search query can be more important, in terms of improving such a classifier in a manner that will be more impactful, across a greater quantity of users, then can be evaluation data indicating that the classifier is incorrectly classifying an uncommon search query. Consequently, according to such an aspect, various metadata of the strata can be utilized to weight the corresponding evaluation data 289. One such metadata can be a quantity of individual, discrete data sets in the stratum from which the data sample, on which such evaluation data 289 is based, was selected by the sample selector 250. Consequently, strata having a greater quantity of individual, discrete data sets can result in higher weightings for evaluation data proceeding from a sample, such as one of the data samples 260, that was selected from such strata. Conversely, strata having few individual, discrete data sets can result in lower weightings for evaluation data that proceeds from a sample that was selected from such strata. Other metadata can include a summation or aggregation of the individual sets of data within a stratum, an average, median or mean value of one or more aspects of the individual sets of data within a stratum, a range or minimum and maximum values of one or more aspects of the individual sets of data within a stratum, or other like metadata.

In an analogous manner, according to one aspect, the training data 299, generated by the trainer 190, can be similarly weighted. More specifically, the trainer 190, as indicated previously, can generate the training data 299 by combining the human-generated classifications 179 with the corresponding input from the corresponding data samples 260. For example, the data sample 261 can comprise an input that was provided to one of the human workers 170, causing such a human worker to generate the human-generated classification 271. As in the case of the classification evaluator 180, according to one aspect, the trainer 190 can treat the human-generated classification 271 as the correct classification for the input from the data sample 261. Consequently, to generate one of the training data 299, the trainer 190 can associate human-generated classification 271 with the input from the data sample 261, providing such a human-generated classification 271 as the correct classification for the input from the data sample 261. As indicated, such training data 299 can be weighted in a manner analogous to that described in detail above with respect to the evaluation data 289. More specifically, such training data 299 to be weighted in accordance with aspects of the population of the strata from which the sample selector 250 selected the data sample, such as the exemplary data sample 261, on which the training data 299 is based.

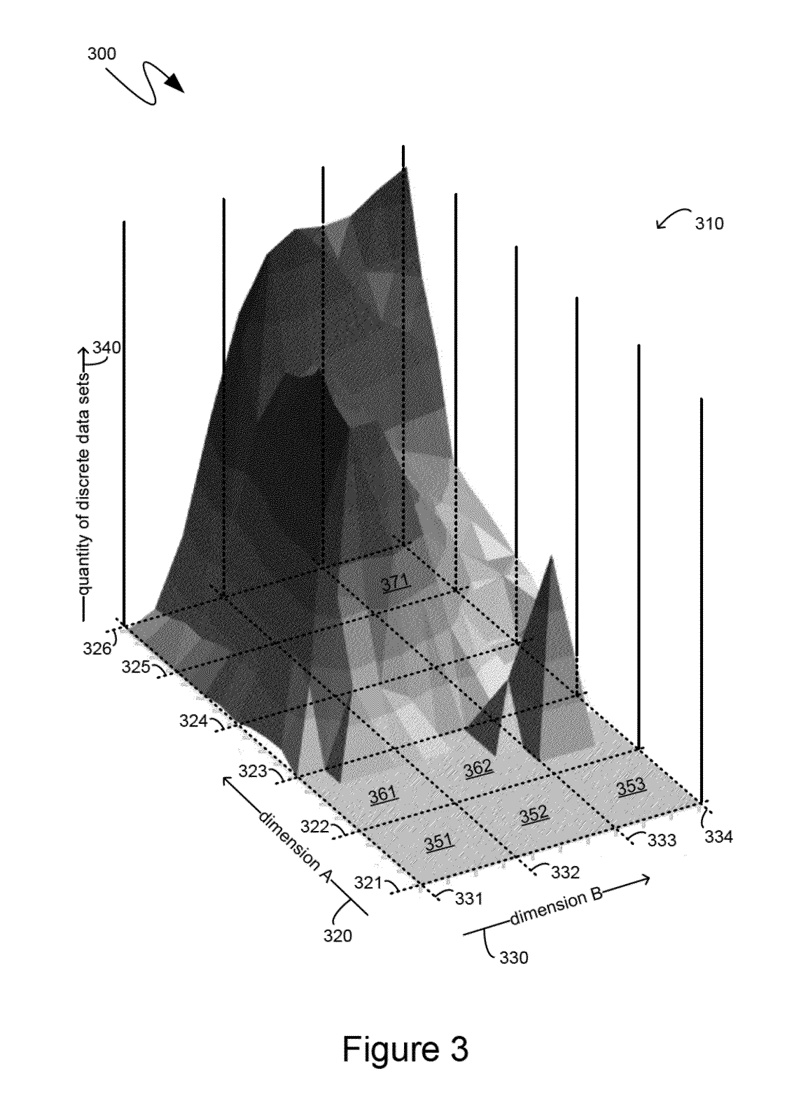

Turning to FIG. 3, the exemplary visualization 300 shown therein illustrates one aspect of conceptualizing and visualizing data from the data corpus as evaluated across multiple dimensions. More specifically, the three-dimensional graph 310 illustrates a quantity of data samples along a vertical axis 340, as grouped by two dimensions displayed along horizontal axes, namely the dimensions 320 and 330. Providing a concrete example for purposes of illustration and ease of understanding, the three-dimensional graph 310 can represent a quantity of data samples comprising search queries and corresponding machine-generated classifications of such search queries, along with associated metadata. One dimension along which such data can be evaluated can be a confidence in the machine-generated classification. For example, the dimension 330 can represent various degrees of confidence in the machine-generated classification of the data sets graphed by the three-dimensional graph 310, with one threshold 331 representing a high confidence, while the other threshold 334 can represent a low confidence. As can be seen from the exemplary three-dimensional graph 310, a greater quantity of data sets can be associated with lower confidence classifications than with higher confidence ones. As another example, the dimension 320 can represent various different search queries, with one threshold 321 representing uncommon search queries, while the other threshold 326 represents common search queries. Unsurprisingly, given such an example, the three-dimensional graph 310 can indicate a greater quantity of data sets associated with the common search queries, as opposed to the uncommon ones.

As can be seen from the exemplary three-dimensional graph 310, a random sampling of the data sets would result in multiple samples being selected from those data sets associated with common search queries, at the expense of samples from uncommon search queries, which could be wholly unrepresented. Conversely, randomly sampling along the dimension 320 could result in a disproportionately large number of uncommon search queries being selected for the sample, leaving one or more popular search queries unevaluated.

Consequently, as described in detail above, strata can be delineated along the dimensions being evaluated, such as the dimensions 320 and 330. For example, the dimension 330 can be divided by thresholds 331, 332, 333 and 334. In an analogous manner, the dimension 320 can be divided by thresholds 321, 322, 323, 324, 325 and 326. Such strata thresholds can result in exemplary strata 351, 352, 353, 361, 362 and 371. For example, the stratum 351 can be defined by the thresholds 331 and 332 along the dimension 330, and the thresholds 321 and 322 along the dimension 320. As utilized herein, therefore, the term “stratum”, and the corresponding plural term “strata”, mean either a division along a single dimension, having defined upper and lower boundaries, or a division in multiple dimensions defined by the upper and lower boundaries of divisions along each individual dimension. Thus, with reference to FIG. 3, the dimension 330, for example, is stratified into three strata: one defined by threshold 331 as an upper bound and threshold 332 as a lower bound, a second defined by threshold 332 as an upper bound and threshold 333 as a lower bound and a third defined by threshold 333 as an upper bound and threshold 334 as a lower bound. Additionally, the two dimensions along which the data from the data corpus is being evaluated, namely the dimensions 320 and 330, result in two-dimensional strata that are bounded by the stratification boundaries, or thresholds, along each individual dimension. Thus, as indicated, in FIG. 3, stratum 351 is bounded by the thresholds 331 and 332 along the dimension 330 and the thresholds 321 and 322 along the dimension 320.

Returning to the above exemplary definition of the dimension 320 as popularity of search query and the dimension 330 as confidence in an assigned classification, the exemplary stratum 351 can be colloquially referred to as a stratum comprising data sets representing uncommon search queries for which the corresponding machine-generated classifications had high degrees of confidence. Analogously, continuing with such an example, the stratum 353 can be colloquially referred to as a stratum comprising data sets representing uncommon search queries for which the corresponding machine-generated classifications had low degrees of confidence. The exemplary stratum 371 can, maintaining such an example, be colloquially referred to as a stratum comprising data sets representing common search queries for which the corresponding machine-generated classifications had low degrees of confidence.

In accordance with the detailed descriptions provided above, one or more data sets can be selected from each of the strata illustrated in the exemplary visualization 300, including, for example, one or more samples from the stratum 351, one or more samples from the stratum 352, and so on. Additionally, as also described in detail above, the resulting training data, or evaluation data, can be weighted in accordance with aspects of the data sets within a stratum from which a sample was selected on which such resulting training data, or evaluation data, is based. For example, as can be seen by the exemplary visualization 300, should such weighting be based on a quantity of data sets within a stratum, evaluation data, or training data, based upon a sample selected from the stratum 371 can be weighted higher than evaluation data, or training data, based upon a sample selected from, for example, the stratum 351.

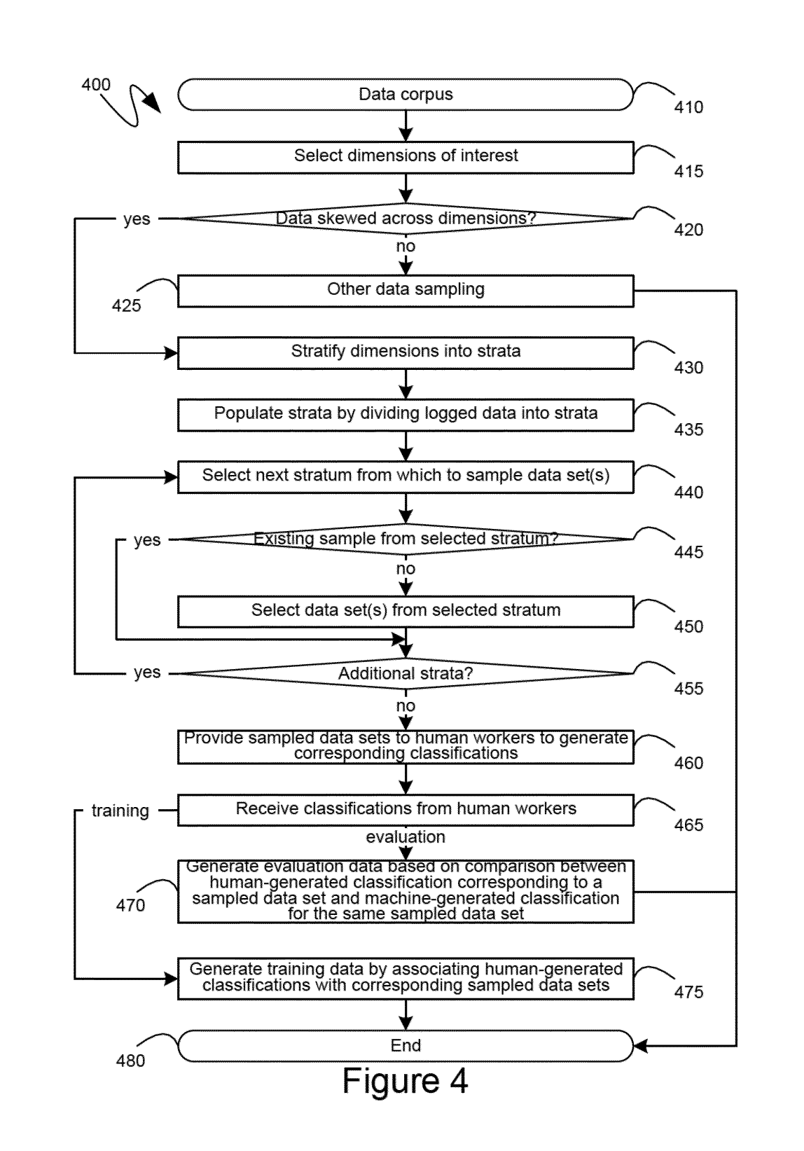

Turning to FIG. 4, the exemplary flow diagram 400 shown therein illustrates an exemplary series of steps by which a computing device's classification can be improved through selective sampling of a small portion of an otherwise very large data corpus that can be skewed along dimensions of evaluation interest. Initially, at step 410 the data corpus can be received as an input to the mechanisms described in detail herein. At step 415, one or more dimensions of interest can be selected. As described previously, such dimensions can represent aspects or categorizations of the data corpus 410, or of metadata thereof. Step 415, as also described previously, can be an automated step, such as if multiple different combinations or permutations of dimensions are selected as part of an automated processing and analysis, or it can be a human-directed step, where the dimensions of interest are selected by a human user, either based on their own analysis, or based on a summary or analysis of the data corpus, obtained at step 410, that can be provided as part of step 415.

Once the dimensions of interest have been selected, such as at step 415, an optional check can be made, at step 420, as to whether the data is skewed across the selected dimensions. For example, according to one aspect, if the data is not skewed, then other data sampling may provide acceptable results and can be performed at step 425, with the relevant processing then ending at step 470. Conversely, if, at optional step 420, it is determined that the data is skewed across the selected dimensions, or is otherwise distributed such that more conventional sampling methodologies may be suboptimal, processing can proceed with step 430. According to another aspect, however, the check, at step 420, need not be performed and processing can proceed from step 415 to step 430.

At step 430, each of the dimensions that were selected at step 415 can be stratified, such as by specifying upper and lower bounds, along each such dimension, for the individual strata along such a dimension. As indicated previously, such stratification can be linear, exponential, logarithmic or additive and can be based on a quantity of data in the data corpus within each stratum along a dimension. Alternatively, as also indicated previously, such stratification can be unrelated in that the disparity between one threshold and another need not be related to the disparity between that other threshold and a still further threshold. Subsequently, at step 435, each stratum, defined by the boundaries established along each of the dimensions at step 430, can be populated with data from the data corpus by dividing the data corpus in accordance with the values of such data in comparison with the established strata boundaries, or thresholds, along each dimension.

At step 440, a process of sampling the individual, discrete data sets from among each of the strata can commence with the selection of a stratum from which to sample one or more individual, discrete data sets. At step 445, a determination can be made as to whether one or more samples from the selected stratum have already been selected. If no previous sampling has occurred, the check, at step 445, can be skipped and processing can proceed to select one or more individual, discrete sets of data, at step 450, from the stratum that was selected at step 440.

However, as indicated previously, the mechanisms described herein can have a high degree of “maintainability” in that prior sampling can be utilized despite changes in the boundaries or thresholds of the strata, changes in the dimensions themselves, changes in the underlying data corpus, or combinations thereof. Thus, if one or more such changes had been implemented, then the above-described steps can have been repeated after such changes and, at step 445 a check could be made of the previously sampled data sets to determine if one or more of those previously sampled data sets are now data sets that are divided into the stratum that was selected at step 440. If the check at step 445 determines that one or more existing samples are from the stratum selected at step 440, then no further data sets need be sampled from that stratum, and processing can proceed to step 455. Conversely, if the check at step 445 determines that there are no existing samples from the selected stratum, processing can proceed to step 450, and at least one individual, discrete data set can be selected from the selected stratum to serve as one or more samples from that stratum. In such a manner, previously selected and evaluated samples can be reused and the additional processing associated with changes to the boundaries or thresholds of the strata, changes to the dimensions themselves, changes to the underlying data corpus, or combinations thereof can be minimized.

At step 455, a subsequent check can be made to determine if there are additional strata from which samples are to be selected. If there are additional strata that have not yet been selected, at step 440, then processing can return to step 440 and a subsequent one of such strata can be selected at step 440. The performance of steps 445, 450 and 455 can then proceed as described. Once no further strata exist from which at least one individual, discrete set of data has not been selected as a sample, the check, at step 455, can enable processing to proceed with step 460, and the input portion of each individual, discrete data set that was selected at step 450 can be provided to human workers to enable those human workers to independently generate classifications of such input.

The human-generated classifications can be received at step 465, and at steps 470 and 475 they can be utilized in accordance with either evaluation of existing algorithms and functions, or for training and generating improved versions of those algorithms and functions. Consequently, step 465 is illustrated as being connected to one of steps 470 or 475 to signify that the selection of the sampled data sets and the subsequent classifications by the human workers would have been performed for one of two reasons: either to generate training data, evidenced by the illustrated execution flow linking step 465 to step 475, or to perform an evaluation, as evidenced by the illustrated execution flow linking step 465 to step 470. Should such a purpose have been to perform an evaluation, then processing can proceed to step 470 where the classifications generated by the human workers, at step 465, can be compared with the classifications of the same input that were generated by the computing device and were logged into the data corpus, access to which was initially obtained at step 410. As described in detail above, such evaluations can be weighted in accordance with various metrics derived from the sets of data that were divided into the strata at step 435. As also described in detail above, such evaluations can inform the generation of training data, such as during a subsequent pass through the steps of the flow diagram 400 of FIG. 4.

Conversely, should the purpose of the sampling and subsequent analysis by human workers have been to generate training data, then processing can proceed from step 465 to step 475, where the training data can be generated by associating the human generated classifications as the correct classifications for the corresponding input from the sample data sets in the manner described in detail above. Although not specifically illustrated, such training data can then be utilized in a manner known to those of skill in the art to train machine learning algorithms, such as those implemented by the above-described classifier. Subsequent to the performance of either step 470 or step 475, the relevant processing can end at step 480.

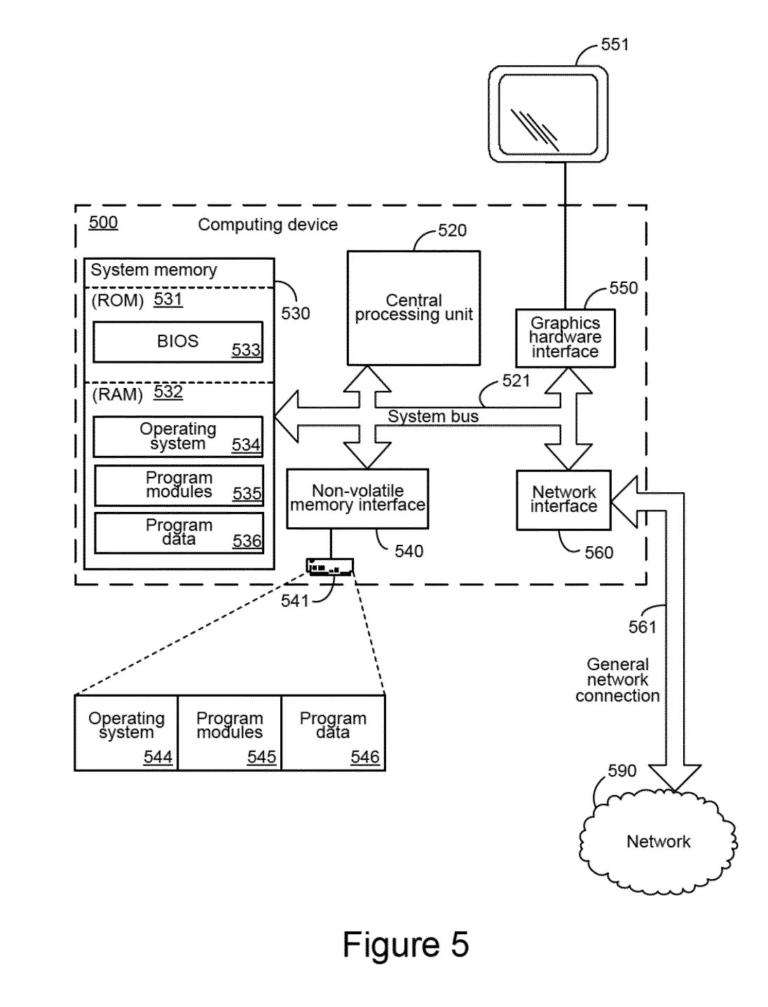

Turning to FIG. 5, an exemplary computing device 500 is illustrated which can perform some or all of the mechanisms and actions described above. The exemplary computing device 500 can include, but is not limited to, one or more central processing units (CPUs) 520, a system memory 530, and a system bus 521 that couples various system components including the system memory to the processing unit 520. The system bus 521 may be any of several types of bus structures including a memory bus or memory controller, a peripheral bus, and a local bus using any of a variety of bus architectures. The computing device 500 can optionally include graphics hardware, including, but not limited to, a graphics hardware interface 550 and a display device 551, which can include display devices capable of receiving touch-based user input, such as a touch-sensitive, or multi-touch capable, display device. Depending on the specific physical implementation, one or more of the CPUs 520, the system memory 530 and other components of the computing device 500 can be physically co-located, such as on a single chip. In such a case, some or all of the system bus 521 can be nothing more than silicon pathways within a single chip structure and its illustration in FIG. 5 can be nothing more than notational convenience for the purpose of illustration.

The computing device 500 also typically includes computer readable media, which can include any available media that can be accessed by computing device 500 and includes both volatile and nonvolatile media and removable and non-removable media. By way of example, and not limitation, computer readable media may comprise computer storage media and communication media. Computer storage media includes media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by the computing device 500. Computer storage media, however, does not include communication media. Communication media typically embodies computer readable instructions, data structures, program modules or other data in a modulated data signal such as a carrier wave or other transport mechanism and includes any information delivery media. By way of example, and not limitation, communication media includes wired media such as a wired network or direct-wired connection, and wireless media such as acoustic, RF, infrared and other wireless media. Combinations of the any of the above should also be included within the scope of computer readable media.

The system memory 530 includes computer storage media in the form of volatile and/or nonvolatile memory such as read only memory (ROM) 531 and random access memory (RAM) 532. A basic input/output system 533 (BIOS), containing the basic routines that help to transfer information between elements within computing device 500, such as during start-up, is typically stored in ROM 531. RAM 532 typically contains data and/or program modules that are immediately accessible to and/or presently being operated on by processing unit 520. By way of example, and not limitation, FIG. 5 illustrates operating system 534, other program modules 535, and program data 536.

The computing device 500 may also include other removable/non-removable, volatile/nonvolatile computer storage media. By way of example only, FIG. 5 illustrates a hard disk drive 541 that reads from or writes to non-removable, nonvolatile magnetic media. Other removable/non-removable, volatile/nonvolatile computer storage media that can be used with the exemplary computing device include, but are not limited to, magnetic tape cassettes, flash memory cards, digital versatile disks, digital video tape, solid state RAM, solid state ROM, and the like. The hard disk drive 541 is typically connected to the system bus 521 through a non-volatile memory interface such as interface 540.

The drives and their associated computer storage media discussed above and illustrated in FIG. 5, provide storage of computer readable instructions, data structures, program modules and other data for the computing device 500. In FIG. 5, for example, hard disk drive 541 is illustrated as storing operating system 544, other program modules 545, and program data 546. Note that these components can either be the same as or different from operating system 534, other program modules 535 and program data 536. Operating system 544, other program modules 545 and program data 546 are given different numbers hereto illustrate that, at a minimum, they are different copies.

The computing device 500 may operate in a networked environment using logical connections to one or more remote computers. The computing device 500 is illustrated as being connected to the general network connection 561 through a network interface or adapter 560, which is, in turn, connected to the system bus 521. In a networked environment, program modules depicted relative to the computing device 500, or portions or peripherals thereof, may be stored in the memory of one or more other computing devices that are communicatively coupled to the computing device 500 through the general network connection 561. It will be appreciated that the network connections shown are exemplary and other means of establishing a communications link between computing devices may be used.

Although described as a single physical device, the exemplary computing device 500 can be a virtual computing device, in which case the functionality of the above-described physical components, such as the CPU 520, the system memory 530, the network interface 560, and other like components can be provided by computer-executable instructions. Such computer-executable instructions can execute on a single physical computing device, or can be distributed across multiple physical computing devices, including being distributed across multiple physical computing devices in a dynamic manner such that the specific, physical computing devices hosting such computer-executable instructions can dynamically change over time depending upon need and availability. In the situation where the exemplary computing device 500 is a virtualized device, the underlying physical computing devices hosting such a virtualized computing device can, themselves, comprise physical components analogous to those described above, and operating in a like manner. Furthermore, virtual computing devices can be utilized in multiple layers with one virtual computing device executed within the construct of another virtual computing device. The term “computing device”, therefore, as utilized herein, means either a physical computing device or a virtualized computing environment, including a virtual computing device, within which computer-executable instructions can be executed in a manner consistent with their execution by a physical computing device. Similarly, terms referring to physical components of the computing device, as utilized herein, mean either those physical components or virtualizations thereof performing the same or equivalent functions.

The descriptions above include, as a first example, a method of improving a computing device's classification accuracy, the method comprising the steps of: obtaining thresholds along each of multiple dimensions along which the computing device's classification accuracy is to be evaluated and improved, the thresholds, in combination, delineating strata in the multiple dimensions; dividing, into collections, with each collection being associated with one unique stratum from the strata, discrete sets of data, wherein each discrete set of data comprises both input data for which the computing device generated a classification and also comprises the classification; selecting at least one discrete set of data from each collection; providing, from the selected at least one discrete set of data from each collection, the input data to a human to generate human-generated classifications of the input data; and either generating an evaluation of the computing device's classification accuracy by comparing the human-generated classifications to the classifications from the selected at least one discrete set of data from each collection or modifying the computing device's classifier utilizing the human-generated classifications and corresponding input data from the selected at least one discrete set of data from each collection of data as training to generate the modified classifier.

A second example is the method of the first example, wherein the selecting the at least one discrete set of data from each collection comprises: first determining if a previously selected discrete set of data has been divided into a collection; and only selecting the at least one discrete set of data from that collection if no previously selected discrete set of data has been divided into that collection.

A third example is the method of the first example, further comprising the steps of: weighting comparisons of the human-generated classifications to the classifications from the selected at least one discrete set of data from each collection based on each collection's metadata.

A fourth example is the method of the third example, wherein each collection's metadata is a quantity of discrete data sets in each collection.

A fifth example is the method of the first example, wherein the training to generate the modified classifier is informed by a previously generated evaluation of the computing device's classification accuracy.

A sixth example is the method of the first example, wherein the multiple dimensions comprise at least one of a commonness of a search query and a confidence in a classification assigned to a search query.

A seventh example is the method of the first example, wherein the thresholds are on a logarithmic scale.

An eighth example is the method of the first example, further comprising the steps of: selecting the thresholds based on a quantity of discrete sets of data between the thresholds.

A ninth example is a computing device comprising: a dimensional stratifier comprising one or more processing units and computer-readable media having computer-executable instructions that, when executed by the one or more processing units, cause the computing device to obtain thresholds along each of multiple dimensions along which the computing device's classification accuracy is to be evaluated and improved, the thresholds, in combination, delineating strata in the multiple dimensions; a strata populator comprising one or more processing units and computer-readable media having computer-executable instructions that, when executed by the one or more processing units, cause the computing device to divide into collections, with each collection being associated with one unique stratum from the strata, discrete sets of data, wherein each discrete set of data comprises both input data for which the computing device generated a classification and also comprises the classification; a sample selector comprising one or more processing units and computer-readable media having computer-executable instructions that, when executed by the one or more processing units, cause the computing device to select at least one discrete set of data from each collection; a classification evaluator comprising one or more processing units and computer-readable media having computer-executable instructions that, when executed by the one or more processing units, cause the computing device to generate an evaluation of the computing device's classification accuracy by comparing human-generated classifications, generated by humans from input data from the selected at least one discrete set of data from each collection, to the classifications from the selected at least one discrete set of data from each collection; and a trainer comprising one or more processing units and computer-readable media having computer-executable instructions that, when executed by the one or more processing units, cause the computing device to modify the computing device's classifier utilizing the human-generated classifications and corresponding input data from the selected at least one discrete set of data from each collection of data as training to generate the modified classifier.

A tenth example is the computing device of the ninth example, wherein the sample selector comprises further computer-readable media having computer-executable instructions that, when executed by the one or more processing units, cause the computing device to: first determine if a previously selected discrete set of data has been divided into a collection; and only select the at least one discrete set of data from that collection if no previously selected discrete set of data has been divided into that collection.

An eleventh example is the computing device of the ninth example, comprising further computer-readable media having computer-executable instructions that, when executed by the one or more processing units, cause the computing device to weight comparisons of the human-generated classifications to the classifications from the selected at least one discrete set of data from each collection based on each collection's metadata.

A twelfth example is the computing device of the eleventh example, wherein each collection's metadata is a quantity of discrete data sets in each collection.

A thirteenth example is the computing device of the ninth example, wherein the training to generate the modified classifier is informed by a previously generated evaluation of the computing device's classification accuracy.

A fourteenth example is the computing device of the ninth example, wherein the multiple dimensions comprise at least one of a commonness of a search query and a confidence in a classification assigned to a search query.

A fifteenth example is the computing device of the ninth example, comprising further computer-readable media having computer-executable instructions that, when executed by the one or more processing units, cause the computing device to selecting the thresholds based on a quantity of discrete sets of data between the thresholds.

A sixteenth example is one or more computer-readable media comprising computer-executable instructions for improving a computing device's classification accuracy, the computer-executable instructions directed to steps comprising: obtaining thresholds along each of multiple dimensions along which the computing device's classification accuracy is to be evaluated and improved, the thresholds, in combination, delineating strata in the multiple dimensions; dividing, into collections, with each collection being associated with one unique stratum from the strata, discrete sets of data, wherein each discrete set of data comprises both input data for which the computing device generated a classification and also comprises the classification; selecting at least one discrete set of data from each collection; providing, from the selected at least one discrete set of data from each collection, the input data to a human to generate human-generated classifications of the input data; and either generating an evaluation of the computing device's classification accuracy by comparing the human-generated classifications to the classifications from the selected at least one discrete set of data from each collection or modifying the computing device's classifier utilizing the human-generated classifications and corresponding input data from the selected at least one discrete set of data from each collection of data as training to generate the modified classifier.

A seventeenth example is the computer-readable media of the sixteenth example, wherein the selecting the at least one discrete set of data from each collection comprises: first determining if a previously selected discrete set of data has been divided into a collection; and only selecting the at least one discrete set of data from that collection if no previously selected discrete set of data has been divided into that collection.

An eighteenth example is the computer-readable media of the sixteenth example, comprising further computer-executable instructions directed to weighting comparisons of the human-generated classifications to the classifications from the selected at least one discrete set of data from each collection based on each collection's metadata.

A nineteenth example is the computer-readable media of the eighteenth example, wherein each collection's metadata is a quantity of discrete data sets in each collection.

A twentieth example is the computer-readable media of the sixteenth example, wherein the training to generate the modified classifier is informed by a previously generated evaluation of the computing device's classification accuracy.

As can be seen from the above descriptions, mechanisms for improving the operation of a computing device's classifier through selective sampling of data from a data corpus have been presented. In view of the many possible variations of the subject matter described herein, we claim as our invention all such embodiments as may come within the scope of the following claims and equivalents thereto.

We claim:

1. A method of improving a computing device's classification accuracy, the method comprising the steps of:
obtaining thresholds along each of multiple dimensions along which the computing device's classification accuracy is to be evaluated and improved, the thresholds, in combination, delineating strata in the multiple dimensions;
dividing, into collections, with each collection being associated with one unique stratum from the strata, discrete sets of data, wherein each discrete set of data comprises both input data for which the computing device generated a classification and also comprises the classification;
selecting at least one discrete set of data from each collection;
providing, from the selected at least one discrete set of data from each collection, the input data to a human to generate human-generated classifications of the input data; and
either generating an evaluation of the computing device's classification accuracy by comparing the human-generated classifications to the classifications from the selected at least one discrete set of data from each collection or modifying the computing device's classifier utilizing the human-generated classifications and corresponding input data from the selected at least one discrete set of data from each collection of data as training to generate the modified classifier.

2. The method of claim 1, wherein the selecting the at least one discrete set of data from each collection comprises: first determining if a previously selected discrete set of data has been divided into a collection; and only selecting the at least one discrete set of data from that collection if no previously selected discrete set of data has been divided into that collection.

3. The method of claim 1, further comprising the steps of: weighting comparisons of the human-generated classifications to the classifications from the selected at least one discrete set of data from each collection based on each collection's metadata.

4. The method of claim 3, wherein each collection's metadata is a quantity of discrete data sets in each collection.

5. The method of claim 1, wherein the training to generate the modified classifier is informed by a previously generated evaluation of the computing device's classification accuracy.

6. The method of claim 1, wherein the multiple dimensions comprise at least one of a commonness of a search query and a confidence in a classification assigned to a search query.

7. The method of claim 1, wherein the thresholds are on a logarithmic scale.

8. The method of claim 1, further comprising the steps of: selecting the thresholds based on a quantity of discrete sets of data between the thresholds.

9. A computing device comprising:
a dimensional stratifier comprising one or more processing units and computer-readable media having computer-executable instructions that, when executed by the one or more processing units, cause the computing device to obtain thresholds along each of multiple dimensions along which the computing device's classification accuracy is to be evaluated and improved, the thresholds, in combination, delineating strata in the multiple dimensions;
a strata populator comprising one or more processing units and computer-readable media having computer-executable instructions that, when executed by the one or more processing units, cause the computing device to divide into collections, with each collection being associated with one unique stratum from the strata, discrete sets of data, wherein each discrete set of data comprises both input data for which the computing device generated a classification and also comprises the classification;
a sample selector comprising one or more processing units and computer-readable media having computer-executable instructions that, when executed by the one or more processing units, cause the computing device to select at least one discrete set of data from each collection;
a classification evaluator comprising one or more processing units and computer-readable media having computer-executable instructions that, when executed by the one or more processing units, cause the computing device to generate an evaluation of the computing device's classification accuracy by comparing human-generated classifications, generated by humans from input data from the selected at least one discrete set of data from each collection, to the classifications from the selected at least one discrete set of data from each collection; and
a trainer comprising one or more processing units and computer-readable media having computer-executable instructions that, when executed by the one or more processing units, cause the computing device to modify the computing device's classifier utilizing the human-generated classifications and corresponding input data from the selected at least one discrete set of data from each collection of data as training to generate the modified classifier.

10. The computing device of claim 9, wherein the sample selector comprises further computer-readable media having computer-executable instructions that, when executed by the one or more processing units, cause the computing device to: first determine if a previously selected discrete set of data has been divided into a collection; and only select the at least one discrete set of data from that collection if no previously selected discrete set of data has been divided into that collection.

11. The computing device of claim 9, comprising further computer-readable media having computer-executable instructions that, when executed by the one or more processing units, cause the computing device to weight comparisons of the human-generated classifications to the classifications from the selected at least one discrete set of data from each collection based on each collection's metadata.

12. The computing device of claim 11, wherein each collection's metadata is a quantity of discrete data sets in each collection.

13. The computing device of claim 9, wherein the training to generate the modified classifier is informed by a previously generated evaluation of the computing device's classification accuracy.

14. The computing device of claim 9, wherein the multiple dimensions comprise at least one of a commonness of a search query and a confidence in a classification assigned to a search query.

15. The computing device of claim 9, comprising further computer-readable media having computer-executable instructions that, when executed by the one or more processing units, cause the computing device to selecting the thresholds based on a quantity of discrete sets of data between the thresholds.

16. One or more computer-readable media comprising computer-executable instructions for improving a computing device's classification accuracy, the computer-executable instructions directed to steps comprising:
obtaining thresholds along each of multiple dimensions along which the computing device's classification accuracy is to be evaluated and improved, the thresholds, in combination, delineating strata in the multiple dimensions;
dividing, into collections, with each collection being associated with one unique stratum from the strata, discrete sets of data, wherein each discrete set of data comprises both input data for which the computing device generated a classification and also comprises the classification;
selecting at least one discrete set of data from each collection;
providing, from the selected at least one discrete set of data from each collection, the input data to a human to generate human-generated classifications of the input data; and
either generating an evaluation of the computing device's classification accuracy by comparing the human-generated classifications to the classifications from the selected at least one discrete set of data from each collection or modifying the computing device's classifier utilizing the human-generated classifications and corresponding input data from the selected at least one discrete set of data from each collection of data as training to generate the modified classifier.

17. The computer-readable media of claim 16, wherein the selecting the at least one discrete set of data from each collection comprises: first determining if a previously selected discrete set of data has been divided into a collection; and only selecting the at least one discrete set of data from that collection if no previously selected discrete set of data has been divided into that collection.

18. The computer-readable media of claim 16, comprising further computer-executable instructions directed to weighting comparisons of the human-generated classifications to the classifications from the selected at least one discrete set of data from each collection based on each collection's metadata.

19. The computer-readable media of claim 18, wherein each collection's metadata is a quantity of discrete data sets in each collection.

20. The computer-readable media of claim 16, wherein the training to generate the modified classifier is informed by a previously generated evaluation of the computing device's classification accuracy.
